(19) United States
(12) Patent Application Publication
(10) Pub. No.: US 2025/0246103 A1
(43) Pub. Date: Jul. 31, 2025

(54) ELECTRONIC DEVICE AND OPERATION METHOD THEREOF

(71) Applicant: CARUX TECHNOLOGY PTE. LTD., APERIA (SG)

(72) Inventors: Yi-Cheng CHANG, Tainan (Tainan Science Park) (TW); Po-Nien HUANG, Tainan (Tainan Science Park) (TW)

(21) Appl. No.: 19/002,125

(22) Filed: Dec. 26, 2024

Related U.S. Application Data
(60) Provisional application No. 63/624,825, filed on Jan. 25, 2024.

(30) Foreign Application Priority Data
Sep. 11, 2024 (CN) 202411267661.0

(51) Int. Cl. G09G 3/00

(52) U.S. Cl. CPC G09G 3/002; G09G 2320/064; G09G 2320/0686; G09G 2380/10

(57) ABSTRACT

An electronic device includes a local dimming unit, a current driving unit, and a light-emitting diode zone. The local dimming unit generates a dimming control signal according to a current control command. The current driving unit generates a driving signal with a first current or a second current according to the dimming control signal, wherein the second current is greater than the first current. The light-emitting diode zone receives the driving signal and emits light according to the driving signal.

### CROSS REFERENCE TO RELATED APPLICATIONS

This application claims priority of U.S. Provisional Application No. 63/624,825, filed Jan. 25, 2024, and China Patent Application No. 202411267661.0, filed on Sep. 11, 2024, the entirety of which are incorporated by reference herein.

### BACKGROUND OF THE DISCLOSURE

### Field of the Disclosure

The disclosure relates to an electronic device, and in particular, it relates to an electronic device and an operation method thereof capable of adjusting a driving current.

### Description of the Related Art

Maintaining the same brightness of light-emitting diodes in a conventional display device can be accomplished by increasing the driving current. However, doing so may cause problems with the gray levels, which may result in poor quality of the image display. Therefore, a new design is needed to solve the problem described above.

### BRIEF SUMMARY OF THE DISCLOSURE

An embodiment of the disclosure provides an electronic device, which includes a local dimming unit, a current driving unit and a light-emitting diode zone. The local dimming unit is configured to generate a dimming control signal according to a current control command. The current driving unit is configured to generate a driving signal with a first current or a second current according to the dimming control signal, wherein the second current is greater than the first current. The light-emitting diode zone is configured to receive the driving signal and emit light according to the driving signal.

An embodiment of the disclosure provides an operation method of an electronic device, which includes the following steps. A local dimming unit is used to generate a dimming control signal according to a current control command. A current driving unit is used to generate a driving signal with a first current or a second current according to the dimming control signal, wherein the second current is greater than the first current. A light-emitting diode zone is used to receive the driving signal and emit light according to the driving signal.

### BRIEF DESCRIPTION OF THE DRAWINGS

The disclosure can be fully understood by reading the subsequent detailed description and examples with references made to the accompanying drawings, wherein:

FIG. 1 is a schematic view of an electronic device according to an embodiment of the disclosure;

FIG. 2 is a detailed schematic view of a local dimming unit and a current driving unit according to an embodiment of the disclosure;

FIG. 3 is a schematic view of a configuration relationship of a current driving unit and a plurality of light-emitting diodes in a light-emitting diose zone according to an embodiment of the disclosure;

FIG. 4 is a schematic view of a configuration relationship of a current driving unit and a plurality of light-emitting diodes in a light-emitting diose zone according to an embodiment of the disclosure;

FIG. 5 is a schematic view of a configuration relationship of a current driving unit and a plurality of light-emitting diodes in a light-emitting diose zone according to an embodiment of the disclosure;

FIG. 6 is a schematic view of an electronic device according to an embodiment of the disclosure;

FIG. 7 is a schematic view of an electronic device according to an embodiment of the disclosure;

FIG. 8 is a schematic view of an electronic device according to an embodiment of the disclosure;

FIG. 9 is a schematic view of an electronic device according to an embodiment of the disclosure;

FIG. 10 is a flowchart of an operation method of an electronic device according to an embodiment of the disclosure;

### DETAILED DESCRIPTION OF THE DISCLOSURE

In order to make objects, features and advantages of the disclosure more obvious and easily understood, the embodiments are described below, and the detailed description is made in conjunction with the drawings. In order to help the reader to understand the drawings, the multiple drawings in the disclosure may depict a part of the entire device, and the specific components in the drawing are not drawn to scale.

The specification of the disclosure provides various embodiments to illustrate the technical features of the various embodiments of the disclosure. The configuration, quantity, and size of each component in the embodiments are for illustrative purposes, and are not intended to limit the disclosure. In addition, if the reference number of a component in the embodiments and the drawings appears repeatedly, it is for the purpose of simplifying the description, and does not mean to imply a relationship between different embodiments.

Furthermore, use of ordinal terms such as “first”, “second”, etc., in the specification and the claims to describe a claim element does not by itself connote and represent the claim element having any previous ordinal term, and does not represent the order of one claim element over another or the order of the manufacturing method, either. The ordinal terms are used as labels to distinguish one claim element having a certain name from another element having the same name.

In the disclosure, the technical features of the various embodiments may be replaced or combined with each other to complete other embodiments without being mutually exclusive.

In some embodiments of the disclosure, unless specifically defined, the term “coupled” or “electrically connected” may include any direct or indirect means of electrical connection.

In the text, the terms “substantially” or “approximately” usually means within 20%, or within 10%, or within 5%, or within 3%, or within 2%, or within 1%, or within 0.5% of a given value or range. The quantity given here is an approximate quantity. That is, without the specific description of “substantially” or “approximately”, the meaning of “substantially” or “approximately” may still be implied.

The “including” mentioned in the entire specification and claims is an open term, so it should be interpreted as “including or comprising but not limited to”.

Furthermore, “connected or “coupled” herein includes any direct and indirect connection means. Therefore, an element or layer is referred to as being “connected to” or “coupled to” another element or layer, the element or layer can be directly on, connected or coupled to another element or layer or intervening elements or layers may be present. When an element is referred to as being “directly connected to” or “directly coupled to” another element or layer, there are no intervening elements or layers present. If the text describes that a first device on a circuit is coupled to a second device, it indicates that the first device may be directly electrically connected to the second device. When the first device is directly electrically connected to the second device, the first device and the second device are connected through conductive lines or passive elements (such as resistors, capacitors, etc.), and no other electronic elements are connected between the first device and the second device.

In an embodiment, the electronic device may include a display device, a backlight device, an antenna device, a sensing device, a splicing device or a therapeutic diagnosis device, but the disclosure is not limited thereto. The electronic device may be a bendable or flexible electronic device. The display device may be a non-self-luminous type display device or a self-luminous type display device. The antenna device may be a liquid-crystal type antenna device or a non-liquid-crystal type antenna device, and the sensing device may be a sensing device that senses capacitance, light, heat or ultrasound, but the disclosure is not limited thereto. The electronic component may include a passive component and an active component, such as a capacitor, a resistor, an inductor, a diode, a transistor, etc. The diode may include a light-emitting diode or a photodiode. The light-emitting diode may include, for example, an organic light-emitting diode (OLED), a mini LED, a micro LED or a quantum dot LED, but the disclosure is not limited thereto. The splicing device may be, for example, a display splicing device or an antenna splicing device, but the disclosure is not limited thereto. It should be noted that the electronic device may be any arrangement and combination of the above devices, but the disclosure is not limited thereto. Hereinafter, the display device will be used as an electronic device to illustrate to the content of the disclosure, but the disclosure is not limited thereto.

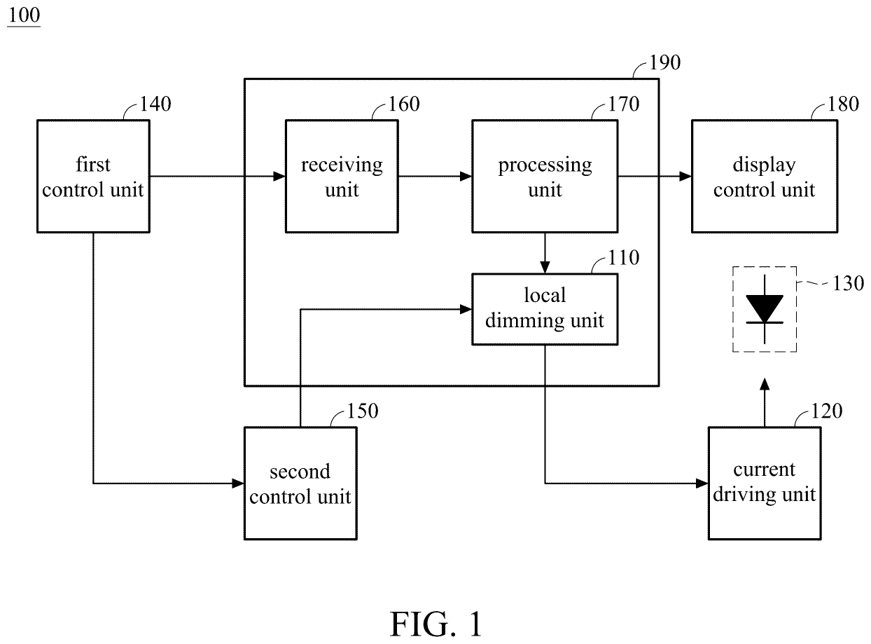

FIG. 1 is a schematic view of an electronic device according to an embodiment of the disclosure. In the embodiment, the electronic device 100 may be suitable for a vehicle electronic product electronic product, such as a head-up display (HUD) or a panoramic head-up display (PHUD), but the disclosure is not limited thereto. Please refer to FIG. 1. The electronic device 100 may at least include a local dimming unit 110, a current driving unit 120 and a light-emitting diode zone 130.

The local dimming unit 110 may generate a dimming control signal according to a current control command. In some embodiments, the above current control command may include a general current control command and a high current control command, but the disclosure is not limited thereto. For example, when the current control command is the general current control command, the local dimming unit 110 may generate the dimming control signal corresponding to the general current control command. In addition, when the current control command is the high current control command, the local dimming unit 110 may generate the dimming control signal corresponding to the high current control command.

The current driving unit 120 may be electrically connected to the local dimming unit 110. The current driving unit 120 may generate a driving signal with a first current or a second current according to the dimming control signal, wherein the second current is greater than the first current. For example, when the dimming control signal corresponds to the general current control command, the current driving unit 120 may generate the driving signal with the first current. When the dimming control signal corresponds to high current control command, the current driving unit 120 may generate the driving signal with the second current. In some embodiments, the second current may be 2 times to 20 times the first current, but the disclosure is not limited thereto. Furthermore, the second current may be 2 times to 4 times the first current. In some embodiments, the current value of the first current is, for example, 15 milliamperes (mA), and the current value of the second current is, for example, 60 milliamperes (mA), but the disclosure is not limited thereto.

The light-emitting diode zone 130 may be electrically connected to the current driving unit 120. The light-emitting diode zone 130 may receive the driving signal with the first current or the second current, and emit light according to the driving signal with the first current or the second current.

In addition, in some embodiments, local dimming unit 110 may also generate a pulse width modulation signal according to the current control command. Furthermore, the light-emitting diode zone 130 may also be electrically connected to the local dimming unit 110 and the current driving unit 120. The light-emitting diode zone 130 may receive the pulse width modulation signal and the driving signal with the first current or the second current, and emit light according to the pulse width modulation signal and the driving signal with the first current or the second current.

In some embodiments, the electronic device 100 may further include a first control unit 140, a second control unit 150, a receiving unit 160, a processing unit 170 and a display control unit 180.

The first control unit 140 may provide a video stream and a module current control command. In some embodiments, the first control unit 140 may be a vehicle control unit (VCU), but the disclosure is not limited thereto. The second control unit 150 may be electrically connected to the first control unit 140 and the local dimming unit 110. The second control unit 150 may receive the module current control command provided by the first control unit 140 and output a second current control command in the format of an application-specific integrated circuit (ASIC) to the local dimming unit 110. The local dimming unit 110 may receive the current control command output by the second control unit 150 and output the dimming control signal (such as a driving current command) to the current driving unit 120. In some embodiments, the second control unit 150 may be a micro control unit (MCU), but the disclosure is not limited thereto.

The receiving unit 160 may be electrically connected to the first control unit 140. The receiving unit 160 may receive the video stream provided by the first control unit 140 and output the video stream. The processing unit 170 may be electrically connected to the receiving unit 160 and the local dimming unit 110. The processing unit 170 may use an algorithm to process the video stream to generate a corresponding processing signal. In some embodiments, the above algorithm may be a local dimming algorithm, but the disclosure is not limited thereto. In addition, the processing unit 170 may be a central processing unit (CPU), a microprocessor, or a micro control unit (MCU), but the disclosure is not limited thereto.

The display control unit 180 may be electrically connected to the processing unit 170. The display control unit 180 may receive the processing signal generated by the processing unit 170, and generate a corresponding display control signal according to the above processing signal, so as to perform subsequent display control. In addition, in some embodiments, the local dimming unit 110, the receiving unit 160 and the processing unit 170 may be integrated into a local dimming controller 190, but the disclosure is not limited thereto.

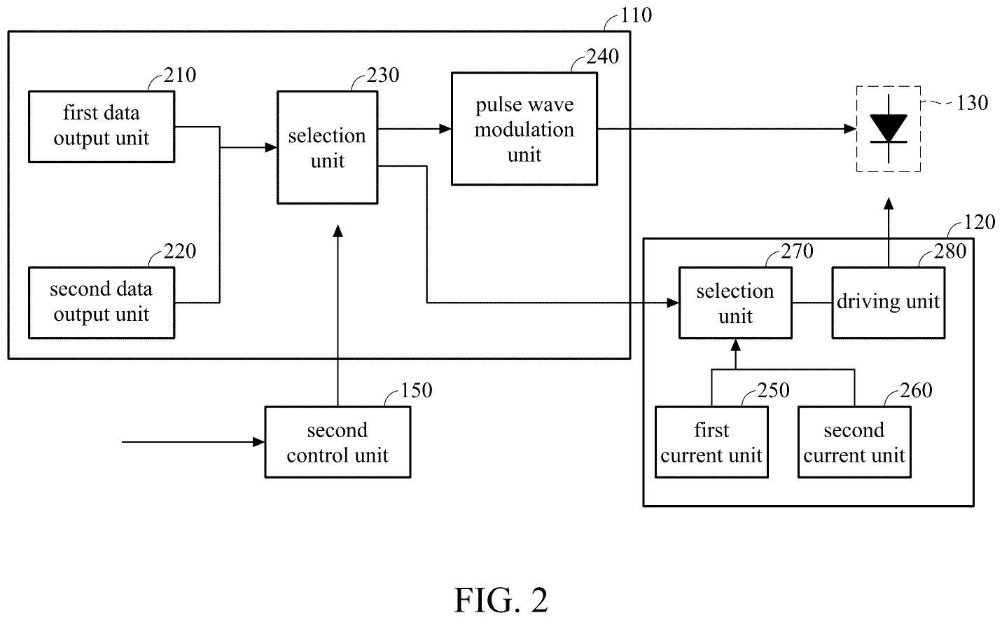

FIG. 2 is a detailed schematic view of a local dimming unit and a current driving unit according to an embodiment of the disclosure. Please refer to FIG. 2. The local dimming unit 110 may include a first data output unit 210, a second data output unit 220, a selection unit 230 and a pulse wave modulation unit 240.

The first data output unit 210 may output first data. The second data output unit 220 may output second data, wherein the bit number of the second data is higher than the bit number of the first data. In some embodiments, the bit number of the first data is, for example, 13 bits and corresponds to 0˜8192 gray levels, and the bit number of the second data is, for example, 15 bits and corresponds to 0˜32768 gray levels, but the disclosure is not limited thereto. In addition, the first data and the second data are local dimming light-emitting diode data, but the disclosure is not limited thereto.

The selection unit 230 may be electrically connected to the first data output unit 210, the second data output unit 220 and the second control unit 150. The selection unit 230 may receive the first data, the second data and the current control command, generate the dimming control signal according to the current control command, and output the first data or the second data. For example, when the current control command is the general current control command, the selection unit 230 may generate the dimming control signal corresponding to the general current control command and output the first data. When the current control command is the high current control command, the selection unit 230 may generate the dimming control signal corresponding to the high current control command and output the second data.

The pulse width modulation (PWM) unit 240 may be electrically connected to the selection unit 230 and the light-emitting diode zone 130. The pulse width modulation unit 240 may receive the first data or the second data, and generate a pulse wave modulation signal corresponding to the first data or the second data to the light-emitting diode zone 130 according to the first data or the second data.

The current driving unit 120 may include a first current unit 250, a second current unit 260, a selection unit 270 and a driving unit 280. The first current unit 250 may provide a first current. The second current unit 260 may provide a second current. In some embodiments, each of the first current unit 250 and the second current unit 260 may be a current source, but the disclosure is not limited thereto.

The selection unit 270 may be electrically connected to the first current unit 250, the second current unit 260 and the local dimming unit 110. The selection unit 270 may receive the first current, the second current and the dimming control signal, and output the first current or the second current according to the dimming control signal. For example, when the dimming control signal corresponds to the general current control command, the selection unit 270 may output the first current. When the dimming control signal corresponds to the high current control command, the selection unit 270 may output the second current.

The driving unit 280 may be electrically connected to the selection unit 270 and the light-emitting diode zone 130. The driving unit 280 may receive the first current or the second current output by the selection unit 270, and generate the driving signal with the first current or the second current to the light-emitting diode zone 130 according to the first current or the second current.

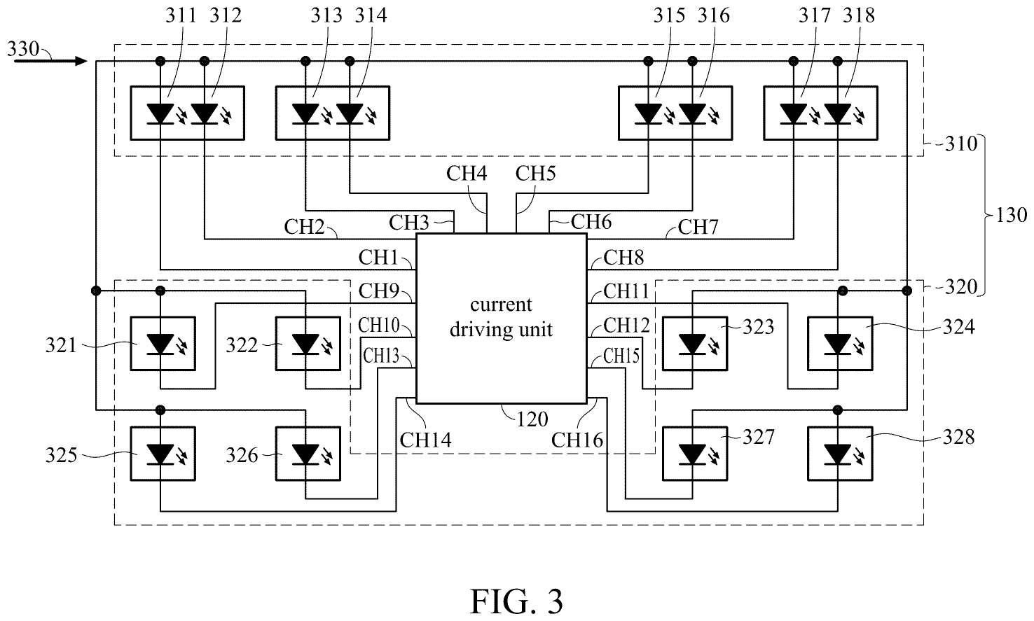

FIG. 3 is a schematic view of a configuration relationship of a current driving unit and a plurality of light-emitting diodes in a light-emitting diose zone according to an embodiment of the disclosure. Please refer to FIG. 3. The light-emitting diode zone 130 may include a first zone 310 and a second zone 320. In some embodiments, the first zone 310 is an edge zone and has high brightness requirements, and the second zone 320 is a non-edge zone and has general brightness requirements, but the disclosure is not limited thereto.

The current driving unit 120 includes a channel CH1, a channel CH2, a channel CH3, a channel CH4, a channel CH5, a channel CH6, a channel CH7, a channel CH8, a channel CH9, a channel CH10, a channel CH11, a channel CH12, a channel CH13, a channel CH14, a channel CH15 and a channel CH16.

The first zone 310 includes a light-emitting diode 311, a light-emitting diode 312, a light-emitting diode 313, a light-emitting diode 314, a light-emitting diode 315, a light-emitting diode 316, a light-emitting diode 317 and a light-emitting diode 318. Anode terminals of the light-emitting diode 311, the light-emitting diode 312, the light-emitting diode 313, the light-emitting diode 314, the light-emitting diode 315, the light-emitting diode 316, the light-emitting diode 317 and the light-emitting diode 318 are electrically connected to the power source 330. A cathode terminal of the light-emitting diode 311 is electrically connected to the channel CH1. A cathode terminal of the light-emitting diode 312 is electrically connected to the channel CH2. A cathode terminal of the light-emitting diode 313 is electrically connected to the channel CH3. A cathode terminal of the light-emitting diode 314 is electrically connected to the channel CH4. A cathode terminal of the light-emitting diode 315 is electrically connected to the channel CH5. A cathode terminal of the light-emitting diode 316 is electrically connected to the channel CH6. A cathode terminal of the light-emitting diode 317 is electrically connected to the channel CH7. A cathode terminal of the light-emitting diode 318 is electrically connected to the channel CH8.

The second zone 320 includes a light-emitting diode 321, a light-emitting diode 322, a light-emitting diode 323, a light-emitting diode 324, a light-emitting diode 325, a light-emitting diode 326, a light-emitting diode 327 and a light-emitting diode 328. Anode terminals of the light-emitting diode 321, the light-emitting diode 322, the light-emitting diode 323, the light-emitting diode 324, the light-emitting diode 325, the light-emitting diode 326, the light-emitting diode 327 and the light-emitting diode 328 are electrically connected to the power source 330. A cathode terminal of the light-emitting diode 321 is electrically connected to the channel CH9. A cathode terminal of the light-emitting diode 322 is electrically connected to the channel CH10. A cathode terminal of the light-emitting diode 323 is electrically connected to the channel CH11. A cathode terminal of the light-emitting diode 324 is electrically connected to the channel CH12. A cathode terminal of the light-emitting diode 325 is electrically connected to the channel CH13. A cathode terminal of the light-emitting diode 326 is electrically connected to the channel CH14. A cathode terminal of the light-emitting diode 327 is electrically connected to the channel CH15. A cathode terminal of the light-emitting diode 328 is electrically connected to the channel CH16.

In the first zone 310 of FIG. 3, the two light-emitting diodes (i.e., the light-emitting diode 311 and the light-emitting diode 312, the light-emitting diode 313 and the light-emitting diode 314, the light-emitting diode 315 and the light-emitting diode 316 or the light-emitting diode 317 and the light-emitting diode 318) are connected in parallel to form a light-emitting diode pair and are connected to the two channels (i.e., the channel H1 and the channel CH2, the channel CH3 and the channel CH4, the channel CH5 and the channel CH6 or the channel CH7 and the channel CH8) of the current driving unit 120. Therefore, it may effectively decrease the thermal issue of the light-emitting diode.

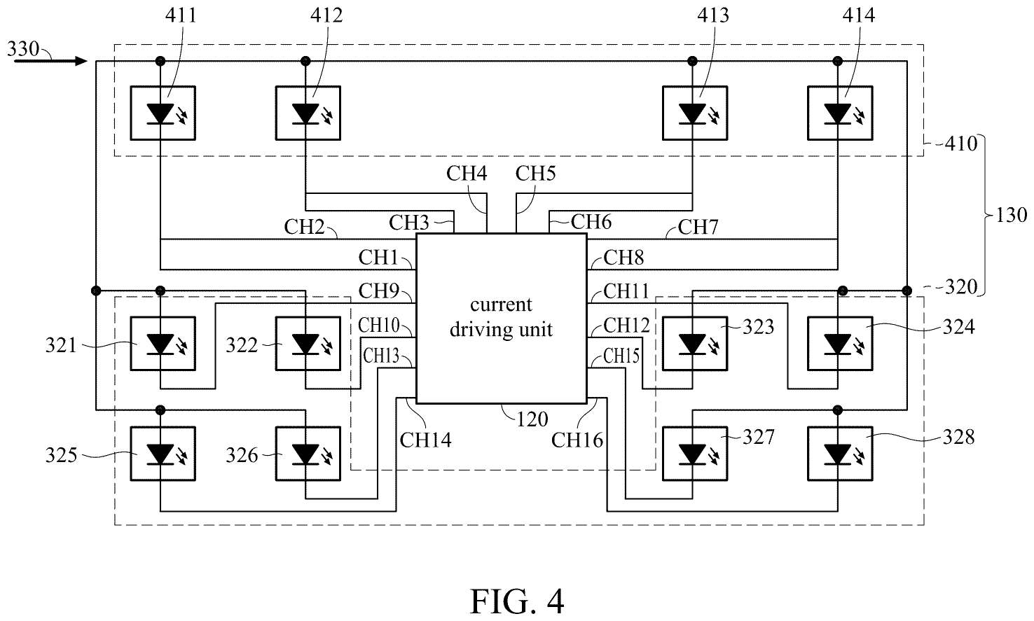

FIG. 4 is a schematic view of a configuration relationship of a current driving unit and a plurality of light-emitting diodes in a light-emitting diose zone according to an embodiment of the disclosure. Please refer to FIG. 4. The light-emitting diode zone 130 may include a first zone 410 and a second zone 320. In some embodiments, the first zone 410 is an edge zone and has high brightness requirements. In addition, the second zone 320 and the internal components thereof in FIG. 4 are the same as or similar to the second zone 320 and the internal components thereof in FIG. 3. Accordingly, the second zone 320 and the internal components thereof in FIG. 4 may refer to the description of the embodiment of FIG. 3, and the description thereof is not repeated herein.

The current driving unit 120 includes a channel CH1, a channel CH2, a channel CH3, a channel CH4, a channel CH5, a channel CH6, a channel CH7, a channel CH8, a channel CH9, a channel CH10, a channel CH11, a channel CH12, a channel CH13, a channel CH14, a channel CH15 and a channel CH16.

The first zone 410 includes a light-emitting diode 411, a light-emitting diode 412, a light-emitting diode 413, a light-emitting diode 414. Anode terminals of the light-emitting diode 411, the light-emitting diode 412, the light-emitting diode 413 and the light-emitting diode 414 are electrically connected to the power source 330. A cathode terminal of the light-emitting diode 411 is electrically connected to the channel CHI and the channel CH2. A cathode terminal of the light-emitting diode 412 is electrically connected to the channel CH3 and the channel CH4. A cathode terminal of the light-emitting diode 413 is electrically connected to the channel CH5 and the channel CH6. A cathode terminal of the light-emitting diode 414 is electrically connected to the channel CH7 and the channel CH8.

In the first zone 410 of FIG. 4, it can be seen that the one light-emitting diode (i.e., the light-emitting diode 411, the light-emitting diode 412, the light-emitting diode 413 or the light-emitting diode 414) is electrically connected to the two channels (i.e., the channel CH1 and the channel CH2, the channel CH3 and the channel CH4, the channel CH5 and the channel CH6 or the channel CH7 and the channel CH8) of the current driving unit 120. Therefore, the light-emitting diode may sustain the larger current.

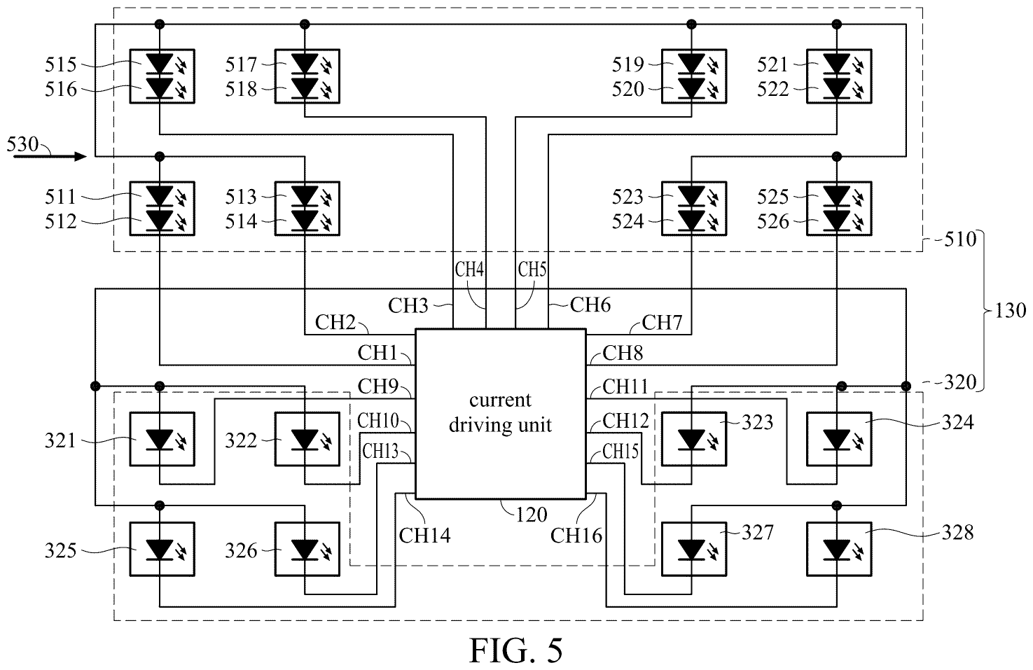

FIG. 5 is a schematic view of a configuration relationship of a current driving unit and a plurality of light-emitting diodes in a light-emitting diose zone according to an embodiment of the disclosure. Please refer to FIG. 5. The light-emitting diode zone 130 may include a first zone 510 and a second zone 320. In some embodiments, the first zone 510 is an edge zone and has high brightness requirements. In addition, the second zone 320 and the internal components thereof in FIG. 5 are the same as or similar to the second zone 320 and the internal components thereof in FIG. 3. Accordingly, the second zone 320 and the internal components thereof in FIG. 5 may refer to the description of the embodiment of FIG. 3, and the description thereof is not repeated herein.

The current driving unit 120 includes a channel CH1, a channel CH2, a channel CH3, a channel CH4, a channel CH5, a channel CH6, a channel CH7, a channel CH8, a channel CH9, a channel CH10, a channel CH11, a channel CH12, a channel CH13, a channel CH14, a channel CH15 and channel CH16.

The first zone 510 includes a light-emitting diode 511, a light-emitting diode 512, a light-emitting diode 513, a light-emitting diode 514, a light-emitting diode 515, a light-emitting diode 516, a light-emitting diode 517, a light-emitting diode 518, a light-emitting diode 519, a light-emitting diode 520, a light-emitting diode 521, a light-emitting diode 522, a light-emitting diode 523, a light-emitting diode 524, a light-emitting diode 525 and a light-emitting diode 526. Anode terminals of the light-emitting diode 511, the light-emitting diode 513, the light-emitting diode 515, the light-emitting diode 517, the light-emitting diode 519, the light-emitting diode 521, the light-emitting diode 523 and the light-emitting diode 525 are electrically connected to the power source 530.

An anode terminal of the light-emitting diode 512 is electrically connected to a cathode terminal of the light-emitting diode 511, and a cathode terminal of the light-emitting diode 512 is electrically connected to the channel CH1. An anode terminal of the light-emitting diode 514 is electrically connected to a cathode terminal of the light-emitting diode 513, and a cathode terminal of the light-emitting diode 514 is electrically connected to the channel CH2. An anode terminal of the light-emitting diode 516 is electrically connected to a cathode terminal of the light-emitting diode 515, and a cathode terminal of the light-emitting diode 516 is electrically connected to the channel CH3. An anode terminal of the light-emitting diode 518 is electrically connected to a cathode terminal of the light-emitting diode 517, and a cathode terminal of the light-emitting diode 518 is electrically connected to the channel CH4.

An anode terminal of the light-emitting diode 520 is electrically connected to a cathode terminal of the light-emitting diode 519, and a cathode terminal of the light-emitting diode 520 is electrically connected to the channel CH5. An anode terminal of the light-emitting diode 522 is electrically connected to a cathode terminal of the light-emitting diode 521, and a cathode terminal of the light-emitting diode 522 is electrically connected to the channel CH6. An anode terminal of the light-emitting diode 524 is electrically connected to a cathode terminal of the light-emitting diode 523, and a cathode terminal of the light-emitting diode 524 is electrically connected to the channel CH7. An anode terminal of the light-emitting diode 528 is electrically connected to a cathode terminal of the light-emitting diode 527, and a cathode terminal of the light-emitting diode 528 is electrically connected to the channel CH8.

In the first zone 510 of FIG. 5, it can be seen that the two light-emitting diodes (i.e., the light-emitting diode 511 and the light-emitting diode 512, the light-emitting diode 513 and the light-emitting diode 514, the light-emitting diode 515 and the light-emitting diode 516, the light-emitting diode 517 and the light-emitting diode 518, the light-emitting diode 519 and the light-emitting diode 520, the light-emitting diode 521 and the light-emitting diode 522, the light-emitting diode 523 and the light-emitting diode 524, the light-emitting diode 525 and the light-emitting diode 526 or the light-emitting diode 527 and the light-emitting diode) are connected in series and are electrically connected to the one channel (i.e., the channel CH1, the channel CH2, the channel CH3, the channel CH4, the channel CH5, the channel CH6, the channel CH7 or the channel CH8) of the current driving unit 120. Therefore, the efficiency of the light-emitting diode may be increased. For example, the efficiency of the light-emitting diode may be increased by 2 times.

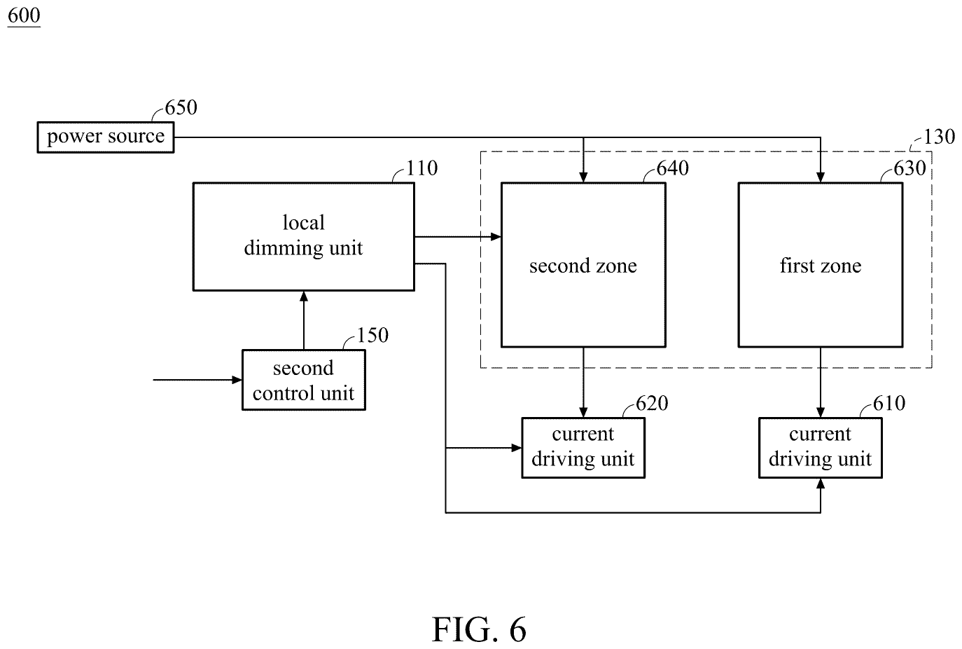

FIG. 6 is a schematic view of an electronic device according to an embodiment of the disclosure. In the embodiment, the electronic device 600 may be suitable for a vehicle electronic product electronic product, such as a head-up display or a panoramic head-up display, but the disclosure is not limited thereto. Please refer to FIG. 6. The electronic device 600 may at least include a local dimming unit 110, a light-emitting diode zone 130, a second control unit 150, a current driving unit 610, a current driving unit 620 and a power source 650. In the embodiment, the local dimming unit 110 and the second control unit 150 in FIG. 6 are the same as or similar to the local dimming unit 110 and the second control 150 unit in FIG. 1. Accordingly, the local dimming unit 110 and the second control unit in FIG. 6 may refer to the description of the embodiment of FIG. 1, and the description thereof is not repeated herein.

The light-emitting diode zone 130 may include a first zone 630 and a second zone 640. In addition, the first zone 630 may correspond to the first zone 310 of FIG. 3, the first zone 410 of FIG. 4 or the first zone 510 of FIG. 5, and the second zone 640 may correspond to the second zone 320 of FIG. 3, FIG. 4 or FIG. 5. Accordingly, the configuration relationship of the first zone 630, the second zone 640 and the internal components thereof may refer to the description of the embodiment of FIG. 3, FIG. 4 or FIG. 5, and the description thereof is not repeated herein. Furthermore, the first zone 630 may be electrically connected to the local dimming unit 110, the current driving unit 610 and the power source 650. The second zone 640 may be electrically connected to the current driving unit 620 and the power source 650.

In some embodiments, the current driving unit 610 may be the current driving unit 120 of FIG. 1. The current driving unit 610 may be controlled by the local dimming unit 110, and output the driving signal with the second current to the first zone 630. In addition, the second current may be a high current, such as 60 mA, but the disclosure is not limited thereto. In some embodiments, the current driving unit 620 may be the current driving unit 120 of FIG. 1. The current driving unit 620 may be controlled by the local dimming unit 110, and output the driving current with the first current to the second zone 640, In addition, the first current may be a low current, such as 15 mA, but the disclosure is not limited thereto.

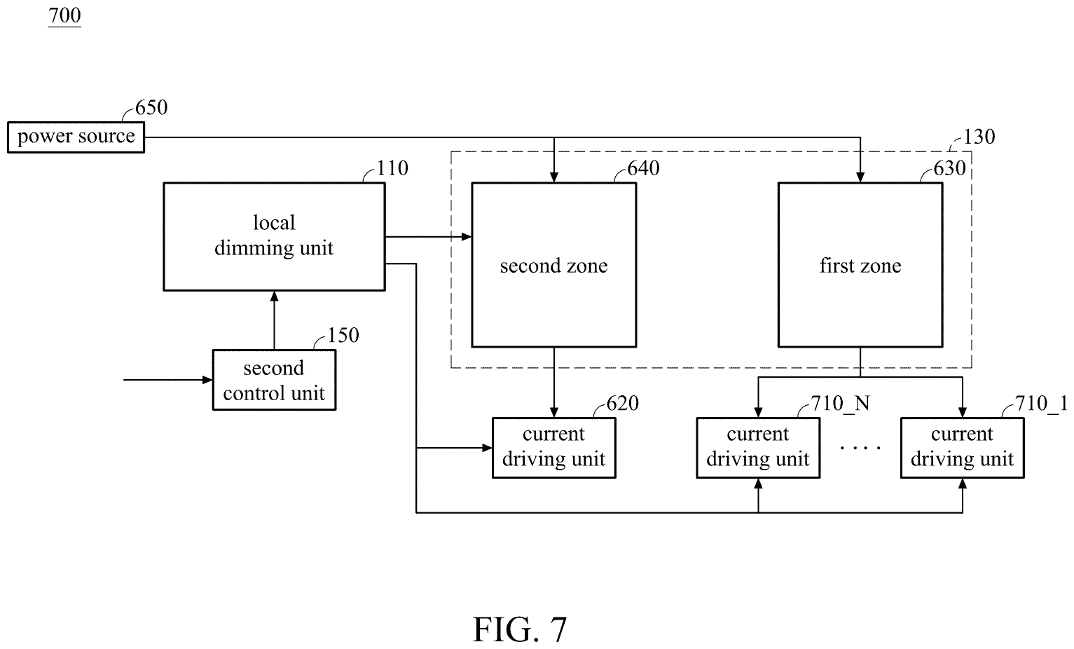

FIG. 7 is a schematic view of an electronic device according to an embodiment of the disclosure. In the embodiment, the electronic device 700 may be suitable for a vehicle electronic product electronic product, such as a head-up display or a panoramic head-up display, but the disclosure is not limited thereto. Please refer to FIG. 7. The electronic device 700 may at least include a local dimming unit 110, a light-emitting diode zone 130, a second control unit 150, a current driving unit 710_1 ˜ a current driving unit 710_N, a current driving unit 620 and a power source 650, wherein N is a positive integer greater than 1. In the embodiment, the local dimming unit 110, the light-emitting diode zone 130, the second control unit 150 and current driving unit 620 in FIG. 7 are the same as or similar to the local dimming unit 110, the light-emitting diode zone 130, the second control unit 150 and current driving unit 620 in FIG. 6. Accordingly, the local dimming unit 110, the light-emitting diode zone 130, the second control unit 150 and current driving unit 620 in FIG. 7 may refer to the description of the embodiment of FIG. 6, and the description thereof is not repeated thereof.

The current driving unit 710_1 ˜ the driving current unit 710_N are electrically connected in parallel and electrically connected to the first zone 630. In some embodiments, each of the current driving unit 710_1 ˜ the current driving unit 710_N may be the current driving unit of FIG. 1. Each of the current driving unit 710_1 ˜ the current driving unit 710_N may be controlled by the local dimming unit 110, and output the driving signal with the first current to the first zone 630. In addition, the first current may be a low current, such as 15 mA, but the disclosure is not limited thereto. That is, the current driving unit 710_1 ˜ the current driving unit 710_N electrically connected in parallel are used to provide the high current to the first zone 630, the use of the current driving units in the first zone 630 may be expanded.

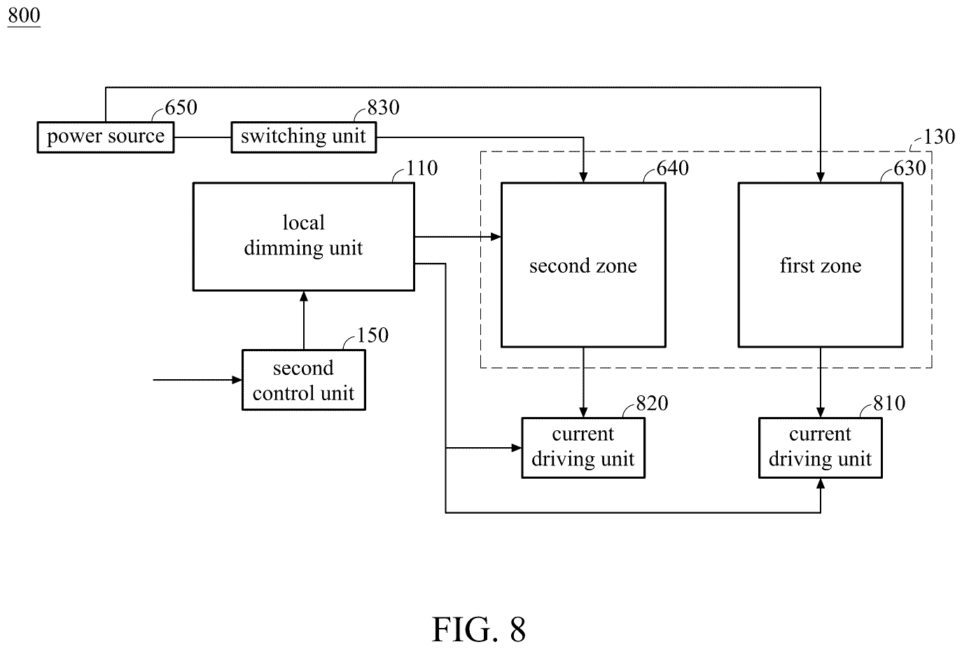

FIG. 8 is a schematic view of an electronic device according to an embodiment of the disclosure. In the embodiment, the electronic device 800 may be suitable for a vehicle electronic product electronic product, such as a head-up display or a panoramic head-up display, but the disclosure is not limited thereto. Please refer to FIG. 8. The electronic device 800 may at least include a local dimming unit 110, a light-emitting diode zone 130, a second control unit 150, a current driving unit 810, a current driving unit 820, a switching unit 830 and a power source 650. In the embodiment, the local dimming unit 110, the light-emitting diode zone 130 and the second control unit 150 in FIG. 8 are the same as or similar to the local dimming unit 110, the light-emitting diode zone 130 and the second control unit 150 in FIG. 6. Accordingly, the local dimming unit 110, the light-emitting diode zone 130 and the second control unit 150 in FIG. 8 may refer to the description of the embodiment of FIG. 6, and the description thereof is not repeated thereof.

In some embodiments, the current driving unit 810 may be a direct type current driving unit. The current driving unit 810 may be controlled by the local dimming unit 110, and output the driving signal with the second current to the first zone 630. In addition, the second current may be a high current, such as 60 mA, but the disclosure is not limited thereto. Furthermore, the operation of the above direct type current driving unit is that one light-emitting diode is controlled by one channel of the current driving unit. In some embodiments, the current driving unit 820 may be a switch type current driving unit. The current driving unit 820 may be controlled by the local dimming unit 110, and output the driving signal with the first current to the zone 640. In addition, the first current may be a low current, such as 15 mA, but the disclosure is not limited thereto. Furthermore, the operation of the switch type current driving unit is that a plurality of light-emitting diodes are controlled by one channel of the current driving unit.

The power source 650 is connected to the first zone 630. The switching unit 830 is electrically connected between the second zone 640 and the power source 650. The switching unit 830 is controlled by a control signal, so as to determine whether to connect the second zone 640 to the power source 650.

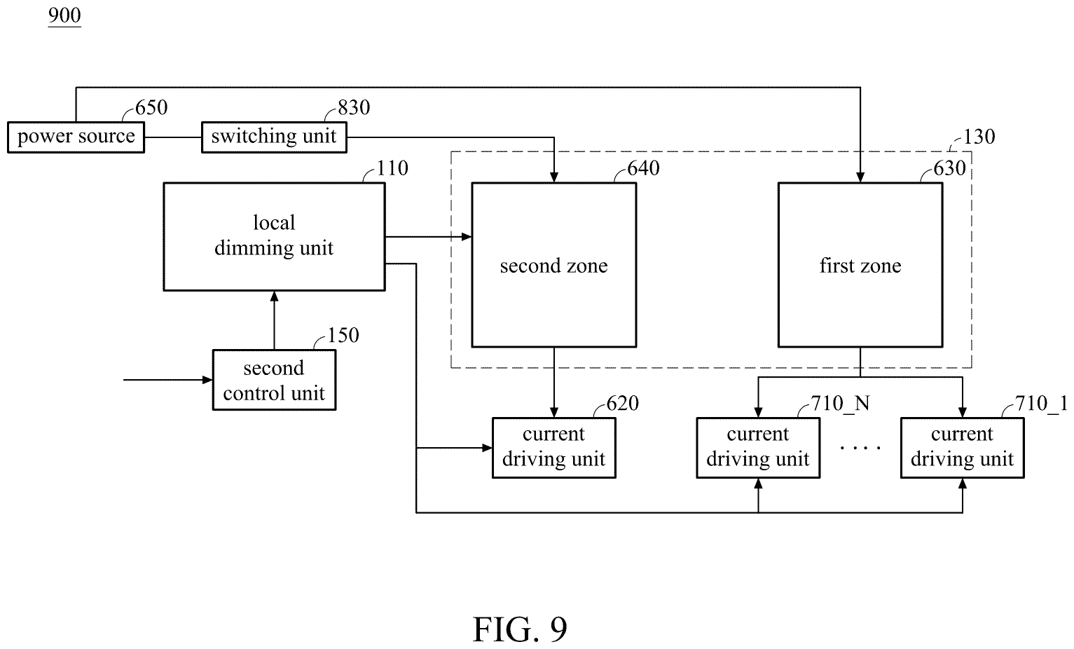

FIG. 9 is a schematic view of an electronic device according to an embodiment of the disclosure. In the embodiment, the electronic device 900 may be suitable for a vehicle electronic product electronic product, such as a head-up display or a panoramic head-up display, but the disclosure is not limited thereto. Please refer to FIG. 9. The electronic device 900 may at least include a local dimming unit 110, a light-emitting diode zone 130, a second control unit 150, a current driving unit 710_1 ˜ a current driving unit 710_N, a current driving unit 620, a switching unit 830 and a power source 650.

In the embodiment, the local dimming unit 130, the second control unit 150, the current driving unit 710_1 ˜ the current driving unit 710_N, the current driving unit 620 and the power source 650 in FIG. 9 are the same as or similar to the local dimming unit 130, the second control unit 150, the current driving unit 710_1 ˜ the current driving unit 710_N, the current driving unit 620 and the power source 650 in FIG. 7. Accordingly, the local dimming unit 130, the second control unit 150, the current driving unit 710_1 ˜ the current driving unit 710_N, the current driving unit 620 and the power source 650 in FIG. 9 may refer to the description of the embodiment of FIG. 7, and the description thereof is not repeated herein. In addition, the switching unit 830 in FIG. 9 is the same as or similar to the switching 830 in FIG. 8. Accordingly, the switching unit 830 in FIG. 9 may refer to the description of the embodiment of FIG. 8, and the description thereof is not repeated herein.

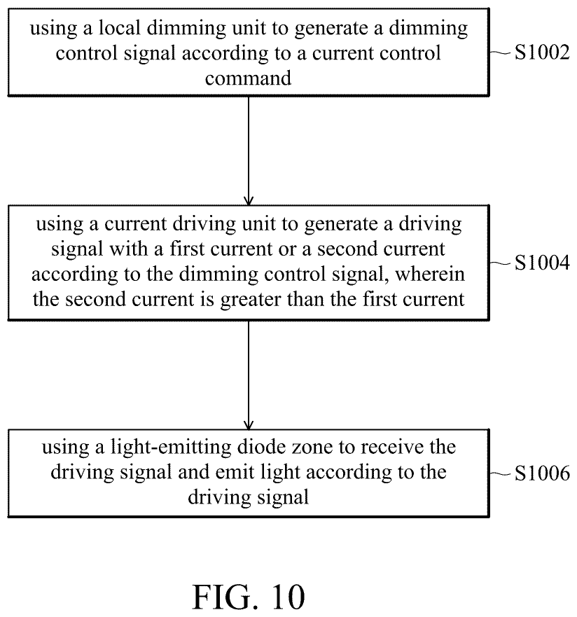

FIG. 10 is a flowchart of an operation method of an electronic device according to an embodiment of the disclosure. In step S1002, the method involves using a local dimming unit to generate a dimming control signal according to a current control command. In step S1004, the method involves using a current driving unit to generate a driving signal with a first current or a second current according to the dimming control signal, wherein the second current is greater than the first current. In step S1006, the method involves using a light-emitting diode zone to receive the driving signal and emit light according to the driving signal.

In summary, according to the electronic device and the operation method thereof disclosed by the embodiments of the disclosure, the local dimming unit generates the dimming control signal according to the current control command. The current driving unit generates the driving signal with the first current or the second current according to the dimming control signal, wherein the second current is greater than the first current. The light-emitting diode zone emits light according to the driving signal. Therefore, it may effectively increase the current of the driving signal, decrease the loss of gray level resolution, or increase the image display quality.

While the disclosure has been described by way of examples and in terms of the preferred embodiments, it should be understood that the disclosure is not limited to the disclosed embodiments. On the contrary, it is intended to cover various modifications, combinations, and similar arrangements (as would be apparent to those skilled in the art). Therefore, the scope of the appended claims should be accorded the broadest interpretation to encompass all such modifications, combinations, and similar arrangements.

What is claimed is:

1. An electronic device, comprising:
a local dimming unit, configured to generate a dimming control signal according to a current control command;
a current driving unit, configured to generate a driving signal with a first current or a second current according to the dimming control signal, wherein the second current is greater than the first current; and
a light-emitting diode zone, configured to receive the driving signal and emit light according to the driving signal.

2. The electronic device according to claim 1, wherein the light-emitting diode zone comprises at least two light-emitting diodes, each of the at least two light-emitting diodes is electrically connected to a channel of the current driving unit.

3. The electronic device according to claim 2, wherein the at least two light-emitting diodes are electrically connected in parallel, and are electrically connected to two channels of the current driving unit.

4. The electronic device according to claim 2, wherein the at least two light-emitting diodes are electrically connected in series, and are electrically connected to the channel of the current driving unit.

5. The electronic device according to claim 1, wherein the light-emitting diode zone comprises at least one light-emitting diode, and the at least one light-emitting diode is electrically connected to two channels of the current driving unit.

6. The electronic device according to claim 1, wherein the local dimming unit comprises:
a first data output unit, configured to output first data;
a second data output unit, configured to output second data, wherein a bit number of the second data is higher than a bit number of the first data;
a selection unit, configured to generate the dimming control signal according to the current control command, and to output the first data or the second data; and
a pulse wave modulation unit, configured to generate a pulse wave modulation signal according to the first data or the second data.

7. The electronic device according to claim 1, wherein the current driving unit comprises:
a first current unit, configured to provide a first current;
a second current unit, configured to provide a second current;
a selection unit, configured to output the first current or the second current according to the dimming control signal; and
a driving unit, configured to generate the driving signal with the first current or the second current according to the first current or the second current.

8. The electronic device according to claim 1, wherein the light-emitting diode zone comprises a first zone and a second zone, and the electronic device further comprises:
a power source, electrically connected to the first zone; and
a switching unit, electrically connected between the second zone and the power source;
wherein the first zone is different from the second zone.

9. The electronic device according to claim 1, wherein the current control command comprises a general current control command and a high current control command.

10. The electronic device according to claim 1, further comprising:
a processing unit, electrically connected to the local dimming unit, and configured to use an algorithm to process the video stream to generate a processing signal; and
a display control unit, electrically connected to the processing unit, and configured to receive the processing signal and generate a display control signal according to the processing signal.

11. The electronic device according to claim 10, further comprising:
a receiving unit, electrically connected to the processing unit, and configured to receive and output the video stream.

12. The electronic device according to claim 11, wherein the local dimming unit, the receiving unit and the processing unit are integrated into a local dimming controller.

13. The electronic device according to claim 11, further comprising:
a first control unit, electrically connected to the receiving unit, and configured to provide a video stream and a module current control command.

14. The electronic device according to claim 13, further comprising:
a second control unit, electrically connected to the first control unit and the local dimming unit, and configured to receive the module current control command and output the current control command.

15. An operation method of an electronic device, comprising:
using a local dimming unit to generate a dimming control signal according to a current control command;
using a current driving unit to generate a driving signal with a first current or a second current according to the dimming control signal, wherein the second current is greater than the first current; and
using a light-emitting diode zone to receive the driving signal and emit light according to the driving signal.

16. The operation method of the electronic device according to claim 15, wherein the light-emitting diode zone comprises at least two light-emitting diodes, and each of the at least two light-emitting diodes is electrically connected to a channel of the current driving unit.

17. The operation method of the electronic device according to claim 16, wherein the at least two light-emitting diodes are electrically connected in parallel, and are electrically connected to two channels of the current driving unit.

18. The operation method of the electronic device according to claim 16, wherein the at least two light-emitting diodes are electrically connected in series, and are electrically connected to the channel of the current driving unit.

19. The operation method of the electronic device according to claim 15, wherein the light-emitting diode zone comprises at least one light-emitting diode, and the at least one light-emitting diode is electrically connected to two channels of the current driving unit.

20. The operation method of the electronic device according to claim 15, wherein the current control command comprises a general current control command and a high current control command.
